(19) United States
(12) Patent Application Publication
(10) Pub. No.: US 2022/0004005 A1
(43) Pub. Date: Jan. 6, 2022

(54) Optical Systems for Providing Field Angle Dependent Pupil Sizes Within a Waveguide

(71) Applicant: Apple Inc., Cupertino, CA (US)

(72) Inventors: Vikrant Bhakta, Santa Clara, CA (US); Guolin Peng, Sunnyvale, CA (US); Hyungryul Choi, San Jose, CA (US); Scott M. DeLapp, San Diego, CA (US)

(21) Appl. No.: 17/475,850

(22) Filed: Sep. 15, 2021

Related U.S. Application Data
(63) Continuation of application No. PCT/US2020/050914, filed on Sep. 15, 2020.
(60) Provisional application No. 62/905,675, filed on Sep. 25, 2019.

(51) Int. Cl. G02B 27/01

(52) U.S. Cl. CPC G02B 27/0172; G02B 2027/0125; G02B 2027/0178

(57) ABSTRACT

An electronic device may include an emissive display panel that emits light, a waveguide with an output coupler that directs the light towards an eye box, and an input coupler that couples the light into the waveguide. A lens directs the light towards the input coupler. Optical components optically coupled between the display panel and the lens may provide the image light with a field angle dependent pupil size upon coupling of the image light into the waveguide by the input coupler. This prevents light that would otherwise pass into the waveguide at angles unsuitable for total internal reflection from passing to the lens, thereby mitigating stray light in the system and optimizing contrast in the image light received at the eye box. The optical components may include an array of apertures, an array of microlenses, an array of tapered optical tunnels, or an array of optical fibers.

This application is a continuation of international patent application No. PCT/US2020/050914, filed Sep. 15, 2020, which claims the benefit of U.S. provisional patent application No. 62/905,675, filed Sep. 25, 2019, which are hereby incorporated by reference herein in their entireties.

### BACKGROUND

This relates generally to optical systems and, more particularly, to optical systems for displays.

Electronic devices may include displays that present images to a user's eyes. For example, devices such as virtual reality and augmented reality headsets may include displays with optical elements that allow users to view the displays.

It can be challenging to design devices such as these. If care is not taken, the components used in displaying content may be unsightly and bulky and may not exhibit desired levels of optical performance.

### SUMMARY

An electronic device such as a head-mounted device may have one or more near-eye displays that produce images for a user. The head-mounted device may be a pair of virtual reality glasses or may be an augmented reality headset that allows a viewer to view both computer-generated images and real-world objects in the viewer's surrounding environment.

The near-eye display may include an emissive display panel that emits image light and an optical system that redirects the image light towards an eye box. The optical system may include an input coupler and an output coupler formed on a waveguide. The input coupler may be an input coupling prism that couples the image light into the waveguide so that the image light propagates in the waveguide towards the output coupler. The output coupler may couple the image light out of the waveguide and towards the eye box. A collimating lens may direct the image light from the display panel towards the input coupler.

Optical components may be optically coupled between the display panel and the collimating lens. The optical components may provide the image light with a field angle dependent pupil size upon coupling of the image light into the waveguide by the input coupler. For example, the optical components may independently transmit the image light emitted by the display panel, to the collimating lens, within respective angular ranges for each pixel in the display panel. This may prevent light that would otherwise pass into the waveguide at angles unsuitable for total internal reflection from passing to the collimating lens, thereby mitigating stray light in the system and optimizing contrast in the image light received at the eye box. The optical components may include an array of apertures, an array of microlenses, an array of tapered optical tunnels, or an array of optical fibers, as examples.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with an input coupler in accordance with some embodiments.

FIG. 3 is a top view of an illustrative input coupler that couples image light from a lens into a waveguide within a corresponding pupil in accordance with some embodiments.

FIG. 4 is a top view of illustrative optical components that may be used to provide image light with a field angle dependent pupil size when coupled into a waveguide by an input coupler in accordance with some embodiments.

FIG. 5 is a top view showing how an illustrative array of apertures may be used to provide image light with a field angle dependent pupil size when coupled into a waveguide by an input coupler in accordance with some embodiments.

FIG. 6 is a top view showing how an illustrative microlens array may be used to provide image light with a field angle dependent pupil size when coupled into a waveguide by an input coupler in accordance with some embodiments.

FIGS. 7A and 7B show how illustrative tapered optical tunnels may be used to provide image light with a field angle dependent pupil size when coupled into a waveguide by an input coupler in accordance with some embodiments.

FIG. 8 is a top view showing how an illustrative optical fiber array may be used to provide image light with a field angle dependent pupil size when coupled into a waveguide by an input coupler in accordance with some embodiments.

FIG. 9 is a top view showing how an illustrative optical fiber array may be provided with angled output facets in accordance with some embodiments.

FIG. 10 is a top view showing how an illustrative optical fiber array may be provided with an overlying lens in accordance with some embodiments.

FIG. 11 is a top view showing how an illustrative optical fiber array may be provided with microlenses in accordance with some embodiments.

### DETAILED DESCRIPTION

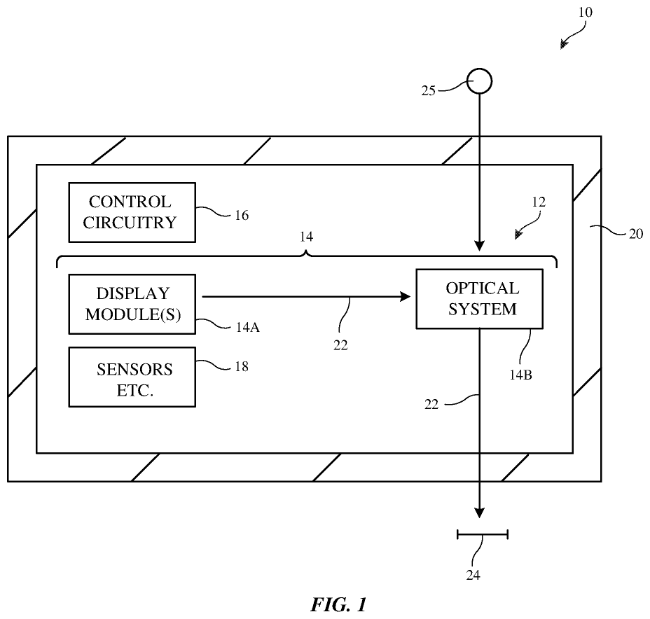

An illustrative system having a device with one or more near-eye display systems is shown in FIG. 1. System 10 may be a head-mounted device having one or more displays such as near-eye displays 14 mounted within support structure (housing) 20. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A and one or more optical systems such as optical systems 14B. Display modules 14A may be mounted in a support structure such as support structure 20. Each display module 14A may emit light 22 (image light) that is redirected towards a user's eyes at eye box 24 using an associated one of optical systems 14B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code (instructions) may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 14A may include reflective displays (e.g., liquid crystal on silicon (LCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in display modules 14A may include uLEDs, OLEDs, LEDs, lasers, combinations of these, or any other desired light-emitting components. Arrangements in which display modules 14A include emissive displays are sometimes described herein as examples.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by components in optical system 14B may be selected so that any gap present between the displays will not be visible to a user (e.g., so that the images of the left and right displays overlap or merge seamlessly).

If desired, optical system 14B may contain components (e.g., an optical combiner, etc.) to allow real-world image light from real-world images or objects 25 to be combined optically with virtual (computer-generated) images such as virtual images in image light 22. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement which a camera captures real-world images of object 25 and this content is digitally merged with virtual content at optical system 14B).

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

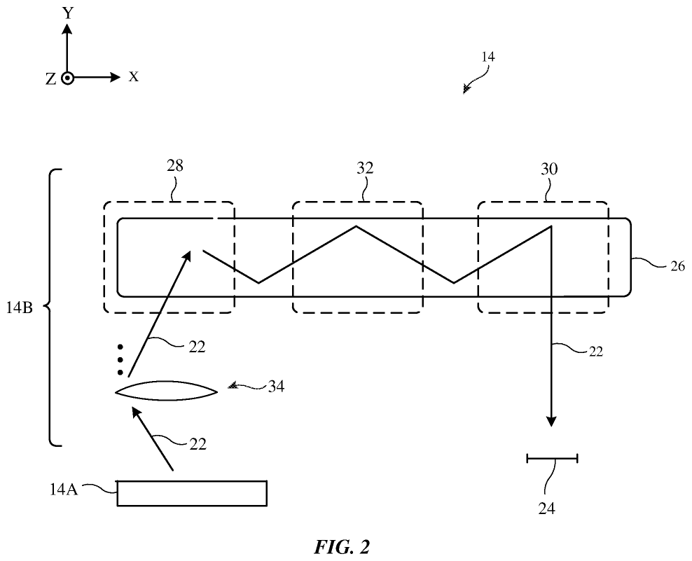

FIG. 2 is a top view of an illustrative display 14 that may be used in system 10 of FIG. 1. As shown in FIG. 2, near-eye display 14 may include one or more display modules such as display module 14A and an optical system such as optical system 14B. Optical system 14B may include optical elements such as one or more waveguides 26. Waveguide 26 may include one or more stacked substrates (e.g., stacked planar and/or curved layers sometimes referred to herein as waveguide substrates) of optically transparent material such as plastic, polymer, glass, etc.

If desired, waveguide 26 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 26 may include holographic phase gratings such as volume holograms or thin-film holograms, meta-gratings, or any other desired diffractive grating structures. The diffractive gratings on waveguide 26 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles).

Optical system 14B may include collimating optics such as collimating lens 34. Lens 34 (sometimes referred to herein as image optics 34 or image lenses 34) may include one or more lens elements that help direct image light 22 towards waveguide 26. If desired, display module 14A may be mounted within support structure 20 of FIG. 1 while optical system 14B may be mounted between portions of support structure 20 (e.g., to form a lens that aligns with eye box 24). Other mounting arrangements may be used, if desired.

As shown in FIG. 2, display module 14A may generate light 22 associated with image content to be displayed to eye box 24. Light 22 may be collimated using a lens such as lens 34. Optical system 14B may be used to present light 22 output from display module 14A to eye box 24.

Optical system 14B may include one or more optical couplers such as input coupler 28, cross-coupler 32, and output coupler 30. In the example of FIG. 2, input coupler 28, cross-coupler 32, and output coupler 30 are formed at or on waveguide 26. Input coupler 28, cross-coupler 32, and/or output coupler 30 may be completely embedded within the substrate layers of waveguide 26, may be partially embedded within the substrate layers of waveguide 26, may be mounted to waveguide 26 (e.g., mounted to an exterior surface of waveguide 26), etc.

The example of FIG. 2 is merely illustrative. One or more of these couplers (e.g., cross-coupler 32) may be omitted. Optical system 14B may include multiple waveguides that are laterally and/or vertically stacked with respect to each other. Each waveguide may include one, two, all, or none of couplers 28, 32, and 30. Waveguide 26 may be at least partially curved or bent if desired.

Waveguide 26 may guide light 22 down its length via total internal reflection. Input coupler 28 may be configured to couple light 22 from display module 14A (lens 34) into waveguide 26, whereas output coupler 30 may be configured to couple light 22 from within waveguide 26 to the exterior of waveguide 26 and towards eye box 24. For example, display module 14A may emit light 22 in direction+Y towards optical system 14B. When light 22 strikes input coupler 28, input coupler 28 may redirect light 22 so that the light propagates within waveguide 26 via total internal reflection towards output coupler 30 (e.g., in direction X). When light 22 strikes output coupler 30, output coupler 30 may redirect light 22 out of waveguide 26 towards eye box 24 (e.g., back along the Y-axis). In scenarios where cross-coupler 32 is formed at waveguide 26, cross-coupler 32 may redirect light 22 in one or more directions as it propagates down the length of waveguide 26, for example.

Input coupler 28, cross-coupler 32, and/or output coupler 30 may be based on reflective and refractive optics or may be based on holographic (e.g., diffractive) optics. In arrangements where couplers 28, 30, and 32 are formed from reflective and refractive optics, couplers 28, 30, and 32 may include one or more reflectors (e.g., an array of micromirrors, partial mirrors, or other reflectors). In arrangements where couplers 28, 30, and 32 are based on holographic optics, couplers 28, 30, and 32 may include diffractive gratings (e.g., volume holograms, surface relief gratings, etc.).

In one suitable arrangement that is sometimes described herein as an example, output coupler 30 is formed from diffractive gratings or micromirrors embedded within waveguide 26 (e.g., volume holograms recorded on a grating medium stacked between transparent polymer waveguide substrates, an array of micromirrors embedded in a polymer layer interposed between transparent polymer waveguide substrates, etc.), whereas input coupler 28 is formed from a reflective prism mounted to an exterior surface of waveguide 26 (e.g., an exterior surface defined by a waveguide substrate that contacts the grating medium or the polymer layer used to form output coupler 30).

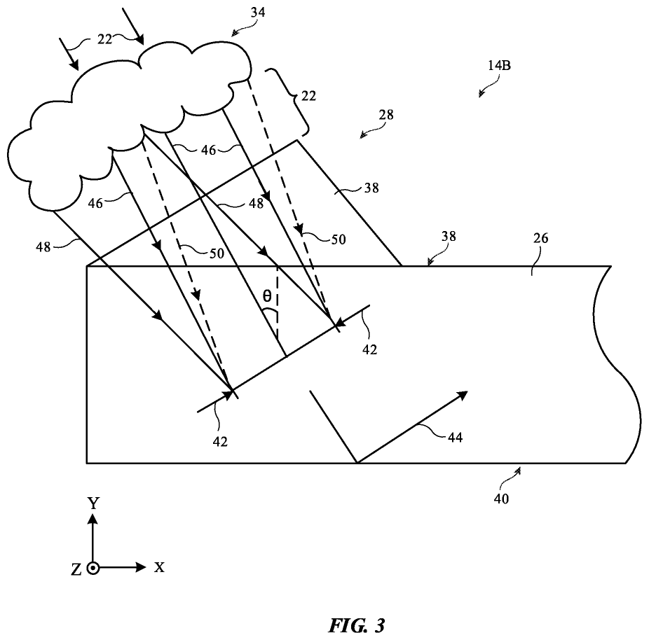

FIG. 3 is a top view showing how input coupler 28 at waveguide 26 may be formed from a prism that couples light 22 into waveguide 26. As shown in FIG. 3, input coupler 28 may include a prism such as prism 36. Prism 36 may have a bottom surface mounted to exterior surface 38 of waveguide 26 (e.g., using an optically clear adhesive not shown in FIG. 3 for the sake of clarity).

In the example of FIG. 3, prism 36 is a transmissive input coupling prism mounted to the side of waveguide 26 facing lens 34 (e.g., surface 38). This is merely illustrative and, in another suitable arrangement, prism 36 may be a reflective input coupling prism mounted to the side of waveguide 26 opposite to lens 34 (e.g., where light 22 from lens 34 first passes through waveguide 26 before reflecting off of an angled surface of the prism and back into waveguide 26 at an angle suitable for total internal reflection to output coupler 30). Other types of input couplers may be used if desired.

As shown in FIG. 3, lens 34 may receive light 22 (e.g., from display module 14A of FIG. 2). Lens 34 may direct light 22 towards prism 36. Prism 36 may direct (couple) light 22 into waveguide 26 at angles such that light 22 propagates down the length of waveguide 26 via total internal reflection, as shown by arrow 44. The angular spread of light 22 upon coupling into waveguide 26 by prism 36 (input coupler 28) may be confined to pupil 42 within waveguide 26 (e.g., the rays of light transmitted by prism 36 may converge at pupil 42 within waveguide 26).

In practice, lens 34 may provide light 22 and prism 36 may couple light 22 into waveguide 26 at a range of incident angles θ (e.g., relative to the normal axis of waveguide surface 38). For example, as shown in FIG. 3, prism 36 may couple light 22 at incident angles θ between a maximum incident angle, as shown by rays 48, and a minimum incident angle, as shown by rays 50. This includes light 22 at intermediate incident angles between the minimum and maximum incident angles, as shown by rays 46. Between these minimum and maximum angles (e.g., from rays 48 to rays 50), lens 34 may converge light 22 and prism 36 may couple light 22 into waveguide 26 (e.g., at angles such that the light can propagate by total internal reflection) within pupil 42.

However, if care is not taken, some of light 22 is incident upon prism 36 and waveguide 26 at angles such that the light at those angles is not coupled into waveguide 26 (e.g., such that the light does not reflect off of waveguide surfaces 40 and 38 via total internal reflection). For example, light incident at angles greater than the maximum incident angle associated with rays 48, less than the minimum incident angle associated with rays 50, or at other incident angles may not be satisfactorily coupled into waveguide 26. This light that is not coupled into waveguide 26 forms stray light that can scatter through system 14B and that minimizes the overall contrast of the image light that is received at eye box 24.

In some scenarios, masking materials are provided on waveguide 26 and/or prism 36 to help mitigate this stray light. However, these masking materials can consume an excessive amount of space, can present manufacturing issues, may not be fully reliable, and/or can unnecessarily complicate the design and operation of optical system 14B. In order to mitigate this stray light without adding masking materials to optical system 14B, display module 14A (FIG. 2) may include optical components that prevent light 22 at these angles (e.g., angles such that the light would not be coupled into waveguide 26 by prism 36 for propagation by total internal reflection) from passing to lens 34.

FIG. 4 is a diagram showing how display module 14A may include optical components that prevent light 22 at these angles (e.g., angles such that the light would not be coupled into waveguide 26 by prism 36 for propagation by total internal reflection) from passing to lens 34. As shown in FIG. 4, display module 14A may include an emissive display panel such as display panel 60. Display panel 60 may include an array or other pattern of display pixels 62. As examples, display panel 60 may be a uLED display panel (e.g., where each pixel 62 is formed using a respective uLED), an OLED panel (e.g., where each pixel 62 is formed using a respective OLED), an LED panel (e.g., where each pixel 62 is formed using a respective LED), a laser panel (e.g., where each pixel 62 is formed using a respective laser or laser die), etc. This is merely illustrative and, if desired, other types of display panels may be used (e.g., transmissive display panels, reflective display panels, etc.).

Each pixel 62 in display panel 60 may emit light 22 within a corresponding light cone. The light emitted by pixels 62 may be characterized by angle relative to the normal axis of display panel 60 (e.g., the spread of angles ϕ of the light 22 emitted by each pixel 62 defines the light cone of that pixel). Lens 34 (e.g., a lens having one or more lens elements that have any desired surfaces such as spherical surfaces, free form surfaces, aspherical surfaces, etc.). Lens 34 converges the light 22 emitted by each pixel 62 in display panel 20 at pupil 42, which is located within waveguide 26 of FIG. 3 (e.g., waveguide 26 and prism 36, which couples light 22 from lens 34 into waveguide 26, are not shown in FIG. 4 for the sake of clarity).

As shown in FIG. 4, display module 14A may include optical components 64 that are optically coupled (e.g., interposed) between display panel 60 and lens 34. The light 22 emitted by display panel 60 passes through optical components 64 before reaching lens 34. Optical components 64 may prevent light 22 from being received at prism 36 and waveguide 26 at incident angles ϕ for which the light, upon passing through prism 36, would not be coupled into waveguide 26. In other words, optical components 64 may provide pupil 42 with a field angle dependent pupil size upon coupling of light 22 into waveguide 26 by prism 36 (e.g., where whether or not the emitted light 22 is coupled into waveguide 26 depends upon the field angle of the light). Optical components 64 may, for example, convert the light 22 emitted by each pixel 62 into an angle (e.g., a range of angles) into waveguide 26.

Optical components 64 may perform these operations by conveying only a subset (range) of the angles ϕ of light 22 emitted by each pixel 62 to lens 34. Optical components 64 may independently convey light 22 from different subsets of angles ϕ to lens 34 for different pixels 62 in display panel 60 (e.g., optical components 64 cause the angles ϕ of light 22 that is provided to lens 34 to vary depending upon which pixel 62 emitted the light). For example, as shown in FIG. 4, optical components 64 may allow light 22 from the lower-most pixel 62 in display panel 60 to pass to lens 34 except within the range of angles Δϕ (e.g., a subset of the total light cone emitted by the lower-most pixel 62). In other words, optical components 64 may block the light 22 from the lower-most pixel 62 within the range of angles Δϕ from passing to lens 34, thereby preventing light that would otherwise have been transmitted to lens 34 and thus to waveguide 26, as shown by shaded region 66, from passing to waveguide 26. The angles that are blocked by optical components 64 (e.g., the range of angles Δϕ for the lower-most pixel 62) may be selected to correspond to incident angles θ (FIG. 3) that prism 36 would not have otherwise coupled into waveguide 26 (e.g., in the absence of optical components 64, light within shaded region 66 may, after passing through prism 36, not be coupled into waveguide 26 at an angle suitable for total internal reflection).

Different ranges of angles Δϕ may be blocked by optical components 64 for different pixels 62 across display panel 60 such that, collectively, no light 22 (or relatively little light 22) that would not have been coupled into waveguide 26 by prism 36 is passed to lens 34 in the first place. This may serve to mitigate stray light at waveguide 26, thereby optimizing the maximum contrast of the images displayed at eye box 24 (e.g., without requiring additional masking layers in optical system 14B).

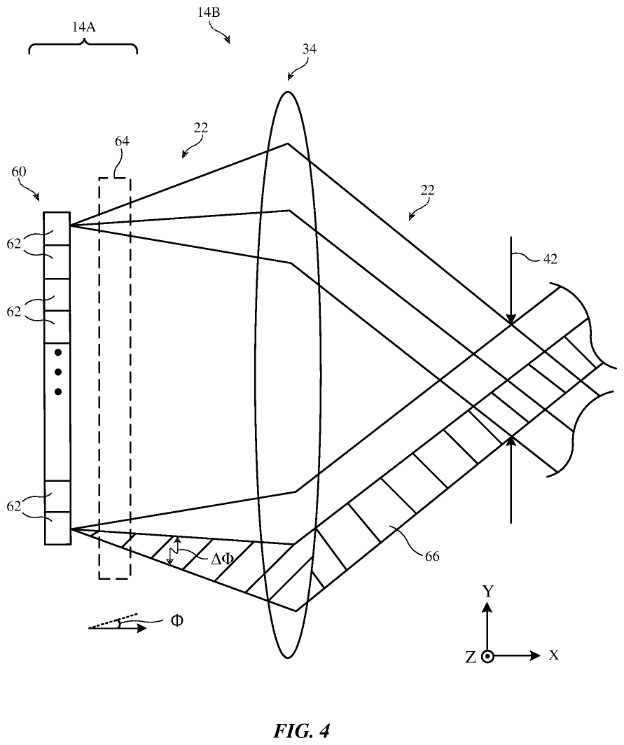

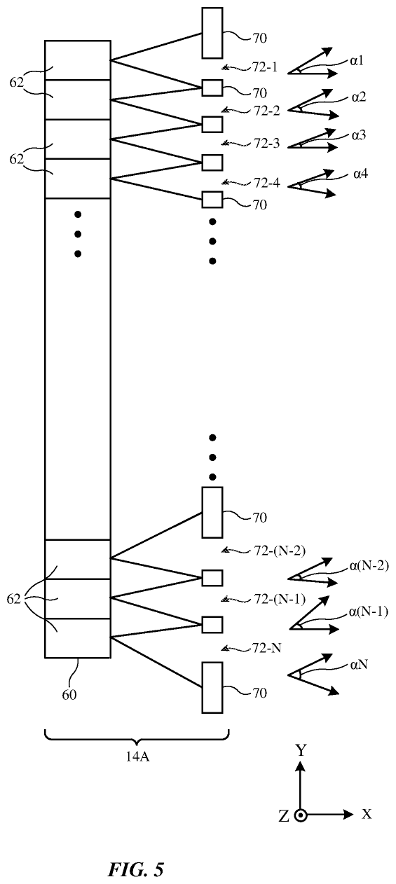

Optical components 64 may include any desired optical components for providing light 22 with a field angle dependent pupil size upon coupling into waveguide 26 by prism 36. FIG. 5 is a diagram showing how optical components 64 may include an array of apertures for providing light 22 with a field angle dependent pupil size upon coupling into waveguide 26 by prism 36.

As shown in FIG. 5, optical components 64 may include an array of apertures 72 (sometimes referred to herein as holes 72 or pinholes 72) in a layer of opaque material 70 (sometimes referred to herein as masking layer 70 or light stops 70). Apertures 72 and the layer of opaque material 70 may sometimes be referred to collectively as an aperture array, an array of apertures, or a pinhole array. Each pixel 62 in display panel 60 may emit light 22. Opaque material 70 may block light 22 whereas apertures 72 transmit light 22.

The array of apertures may control the telecentricity of the light 22 emitted by display panel 60. Each aperture 72 may have a size and a lateral position over a respective pixel 62 such that a desired subset a of the angles of light 22 emitted by that pixel 62 is passed through optical components 64 to lens 34 (FIG. 4). The size and position relative to the underlying pixel 62 of each aperture 72 may vary for each pixel 62 across display panel 60 (e.g., to independently control the angles of light that are provided to lens 34 for each pixel such that, collectively, no light 22 is received at lens 34 that would otherwise not be provided at an incident angle suitable for coupling into waveguide 26).

For example, as shown in FIG. 5, optical components 64 may include a first aperture 72-1 overlapping a first pixel 62, a second aperture 72-2 overlapping a second pixel 62, a third aperture 72-3 overlapping a third pixel 62, a fourth aperture 72-4 overlapping a fourth pixel 62, an (N−2)th aperture 72-(N−2) overlapping an (N−2)th pixel 62, an (N−1)th aperture 72-(N−1) overlapping an (N−1)th pixel 62, an Nth aperture 72-N overlapping an Nth pixel 62, etc. Aperture 72-1 may have a first size and a first lateral position (e.g., within the Y-Z plane of FIG. 5) relative to the first pixel 62 such that aperture 72-1 only passes the light 22 emitted by the first pixel 62 within a first range of angles α1 (e.g., a range of angles ϕ of FIG. 4) to lens 34, while opaque material 70 blocks the light 22 emitted by the first pixel 62 at angles outside of range α1. Similarly, aperture 72-2 may have a second size and a second lateral position relative to the second pixel 62 such that aperture 72-2 only passes the light 22 emitted by the second pixel 62 within a second range of angles α2 to lens 34, while opaque material 70 blocks the light 22 emitted by the second pixel 62 at angles outside of range α2. Similarly, aperture 72-3 may have a third size and a third lateral position relative to the third pixel 62 such that aperture 72-3 only passes the light 22 emitted by the third pixel 62 within a third range of angles α3 to lens 34, while opaque material 70 blocks the light 22 emitted by the third pixel 62 at angles outside of range α3. Each of the remaining N apertures 72 may be independently configured to pass light only within a corresponding range α to lens 34. Ranges α may be different for each pixel 62 in display panel 60 or, if desired, two or more ranges α may be the same for different pixels 62 in display panel 60. In this way, apertures 72 and opaque material 70 may provide light 22 to lens 34 only at angles such that all of the light 22 received at prism 36 will be coupled into waveguide 26.

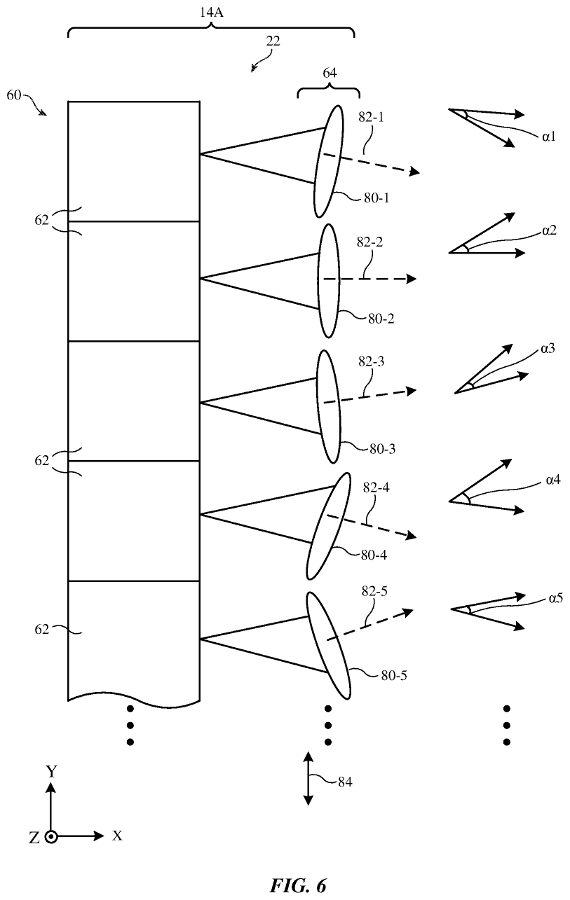

FIG. 6 is a diagram showing how optical components 64 may include an array of microlenses for providing light 22 with a field angle dependent pupil size upon coupling into waveguide 26 by prism 36. As shown in FIG. 6, optical components 64 may include an array of microlenses 80 overlapping respective pixels 62 in display panel 60. The microlenses 80 in optical components 64 may sometimes be referred to collectively herein as a microlens array. Each microlens 80 may have a position relative to its underlying pixel 62, a shape, and/or an orientation that configures the microlens to only transmit light within a corresponding range of angles α to lens 34. The range of angles α may independently vary for each pixel 62 in display panel 60.

For example, as shown in FIG. 6, optical components 64 may include a first microlens 80-1 overlapping a first pixel 62, a second microlens 80-2 overlapping a second pixel 62, a third microlens 80-3 overlapping a third pixel 62, a fourth microlens 80-4 overlapping a fourth pixel 62, a fifth microlens 80-5 overlapping a fifth pixel 62, etc. First microlens 80-1 may have a first orientation (e.g., microlens 80-1 may have an optical axis 82-1 pointing in a first direction). First microlens 80-1 may focus the light 22 from the first pixel 62 that would otherwise be outside of the first range of angles α1 to within the first range of angles α1, such that microlens 80-1 only passes light 22 from the first pixel 62 within the first range of angles α1 to lens 34. Similarly, second microlens 80-2 may have a second orientation (e.g., microlens 80-2 may have an optical axis 82-2 pointing in a second direction different from the first direction). Second microlens 80-2 may focus the light 22 from the second pixel 62 that would otherwise be outside of the second range of angles α2 to within the second range of angles α2, such that microlens 80-2 only passes light 22 from the second pixel 62 within the first range of angles α2 to lens 34. Each of the remaining microlenses 80 may be independently configured to pass light only within a corresponding range α to lens 34. Ranges α may be different for each pixel 62 in display panel 60 or, if desired, two or more ranges α may be the same for different pixels 62 in display panel 60. In this way, microlenses 80 may provide light 22 to lens 34 only at angles such that all of the light 22 received at prism 36 will be coupled into waveguide 26.

The example of FIG. 6 in which microlenses 80 have different orientations for providing a field angle dependent pupil size is merely illustrative. If desired, the relative lateral position of microlenses 80 may be independently configured for each pixel 62 (e.g., within the Y-Z plane, as shown by arrow 84) and/or the shape of microlenses 80 may be independently configured for each pixel 62 to pass light 22 to lens 34 within corresponding ranges α.

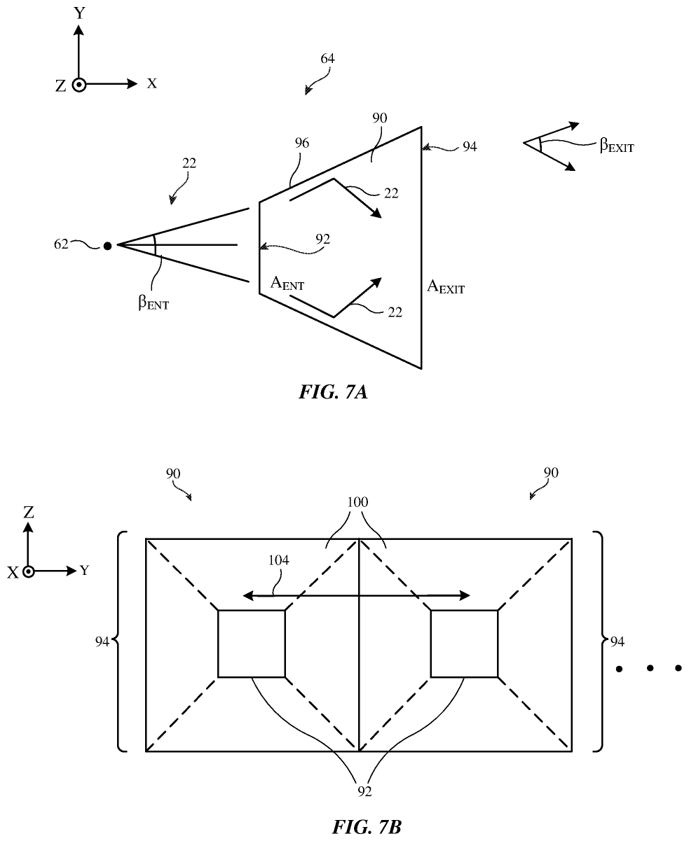

FIGS. 7A and 7B show how optical components 64 may include tapered optical tunnels for providing light 22 with a field angle dependent pupil size upon coupling into waveguide 26 by prism 36. FIG. 7A is a top view of a single tapered optical tunnel 90 that overlaps a respective pixel 62.

As shown in FIG. 7A, tapered optical tunnel 90 may have an input (entrance) face 92 that faces pixel 62, an output (exit) face 94 that faces away from pixel 62 (e.g., towards lens 34 of FIG. 4), and angled (tapered) faces (sidewalls) 96 extending from input face 92 to exit face 94. Input face 92 has a corresponding area A_{ENT}. Output face 94 has a corresponding area A_{EXIT}. Pixel 62 emits light 22, which is received at input (entrance) face 92 within a range of input angles β_{ENT} (e.g., angles β_{ENT} may define the light cone of pixel 62). Light 22 may propagate through tapered optical tunnel 90 while reflecting off of angled faces 96 and may be transmitted through output face 94 within a range of output angles β_{EXIT} (e.g., a range of angles ϕ of FIG. 4 or α of FIGS. 5 and 6).

The size and shape of tapered optical tunnel 90 may be selected to provide light 22 to lens 34 within a desired range of output angles β_{EXIT} (e.g., corresponding to the ranges of angles α of FIGS. 5 and 6). For example, the area A_{ENT} of input face 92 may be selected to provide tapered optical tunnel 90 with the desired range of output angles β_{EXIT}. The area A_{ENT} to use may be determined by multiplying A_{EXIT} by the desired range of output angles β_{EXIt}, divided by the range of input angles β_{INT}, for example.

FIG. 7A shows only a singled tapered optical tunnel 90 for the sake of clarity. However, in general, each pixel 62 in display panel 60 may be provided with a respective overlapping tapered optical tunnel 90. The tapered optical tunnels 90 in optical components 64 may sometimes be referred to collectively herein as an array of tapered optical tunnels or a tapered optical tunnel array. Each tapered optical tunnel may be provided with a respective shape (e.g., a respective area A_{ENT} where all other dimensions are the same) to only provide light 22 emitted by the underlying pixel 62 to lens 34 within a respective range of output angles β_{EXIT}. Ranges β_{EXIT} may be different for each pixel 62 in display panel 60 or, if desired, two or more ranges β_{EXIT} may be the same for different pixels 62 in display panel 60. In this way, the array of tapered optical tunnels 90 may provide light 22 to lens 34 only at angles such that all of the light 22 received at prism 36 will be coupled into waveguide 26.

FIG. 7B is a front view of two adjacent tapered optical tunnels 90. As shown in FIG. 7B, each optical tunnel 90 has a respective input face 92 that overlaps the active area of an underlying pixel 62. The active area of each pixel 62 may be separated from the active area in one or more adjacent pixels 62 by a pixel pitch 104. If care is not taken, the inactive area between adjacent pixels active areas may produce unsightly dark lines between pixels in the image provided to eye box 24. Tapered optical tunnels 90 may, for example, help to mitigate these dark lines by expanding the effective light-emitting area of the pixels from the area of input face 92 to the larger area of output face 94.

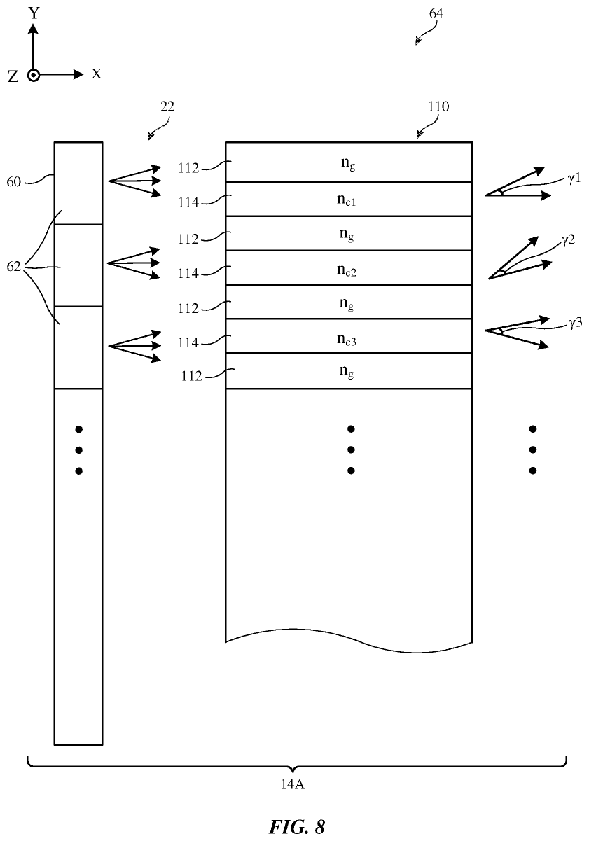

FIG. 8 shows how optical components 64 may include an array of optical fibers for providing light 22 with a field angle dependent pupil size upon coupling into waveguide 26 by prism 36. As shown in FIG. 8, optical components 64 may include an array of optical fibers 110 (sometimes referred to herein as a bundle of optical fibers 110, optical fiber array 110, or optical fiber bundle 110). Optical fiber array 110 may include cores 114 (sometimes referred to herein as optical cores 114 or optical fiber cores 114) that are each surrounded by cladding 114 (e.g., each core 114 and the surrounding cladding 112 may form a single optical fiber in the array). Cores 114 may have a first dielectric constant n_{c} whereas cladding 112 has a second dielectric constant n_{g} that is greater than n_{c}. Cladding 112 may be omitted if desired (e.g., in scenarios where each core 114 has a refractive index different from that of the immediately adjacent cores 114).

Each core 114 may be aligned with a respective pixel 62 in display panel 60. The light 22 emitted by each pixel 62 may enter a corresponding core 114 in optical fiber array 110. Lenses or other microstructures may be used to help couple light 22 into cores 114 if desired. Because of the difference in refractive indices n_{c} and n_{g}, light 22 propagate down cores 114 via total internal reflection and is emitted by core 114 over a range of output angles γ (e.g., corresponding to the ranges of angles α of FIGS. 5 and 6 and to the range of angles (β_{EXIT} in FIG. 7A).

Each core 114 may have an index of refraction n_{c} that is selected so that the core 114 only emits light 22 within a corresponding range of output angles γ to lens 34. The range of angles γ may independently vary for each pixel 62 in display panel 60.

For example, as shown in FIG. 8, optical components 64 may include a first core 114 with a first index of refraction n_{c1} overlapping a first pixel 62, a second core 114 with a second index of refraction n_{c2} overlapping a second pixel 62, a third core 114 with a third index of refraction n_{c3} overlapping a third pixel 62, etc. First index of refraction n_{c1} may be selected so that the first core 114 only emits light 22 from the first pixel within a first range of angles γ1, second index of refraction n_{c2} may be selected so that the second core 114 only emits light 22 from the first pixel within a second range of angles γ2, third index of refraction n_{c3} may be selected so that the third core 114 only emits light 22 from the third pixel within a third range of angles γ3, etc. Each of the remaining cores 114 may be independently configured (e.g., via selection of index of refraction n_{c}) to pass light only within a corresponding range γ to lens 34. Ranges γ may be different for each pixel 62 in display panel 60 or, if desired, two or more ranges γ may be the same for different pixels 62 in display panel 60. In this way, optical fiber array 110 may provide light 22 to lens 34 only at angles such that all of the light 22 received at prism 36 will be coupled into waveguide 26.

The example of FIG. 8 in which cores 114 have different refractive indices for providing a field angle dependent pupil size is merely illustrative. If desired, cores 114 may have angled output facets that configure the cores to emit light 22 only within a respective range of angles γ. FIG. 9 is a diagram showing how cores 114 may have angled output facets that configure the cores to emit light 22 only within a respective range of angles γ.

As shown in FIG. 9, each core 114 may have an output facet (face) 116. Light 22 propagates through cores 114 via total internal reflection and is emitted by output facets 116. Output facets 116 may be independently angled so that light 22 from each pixel 62 is provided to lens 34 only within a corresponding range of angles γ. For example, as shown in FIG. 9, a first core 114 may have an output facet 116 with a first orientation such that light 22 is emitted only by that core within range γ1, a second core 114 may have an output facet 116 with a second orientation such that light 22 is emitted by that core only within range γ2, a third core 114 may have an output facet 116 with a third orientation such that light 22 is emitted by that core only within range γ3, etc. Each of the remaining cores 114 may be independently configured (e.g., via the orientation of its output facet 116) to pass light only within a corresponding range γ to lens 34. Ranges γ may be different for each pixel 62 in display panel 60 or, if desired, two or more ranges γ may be the same for different pixels 62 in display panel 60. In this way, optical fiber array 110 may provide light 22 to lens 34 only at angles such that all of the light 22 received at prism 36 will be coupled into waveguide 26.

The example of FIG. 9 is merely illustrative. Cladding 112 is not shown in FIG. 9 for the sake of clarity. Cladding 112 may be omitted in scenarios where each core 114 has a different refractive index from each of the immediately adjacent cores in array 110. If desired, both the orientation of output facets 116 and the refractive index n_{c} of cores 114 (e.g., as shown in FIG. 8) may be used to configure core 114 to emit light within a corresponding range of output angles γ.

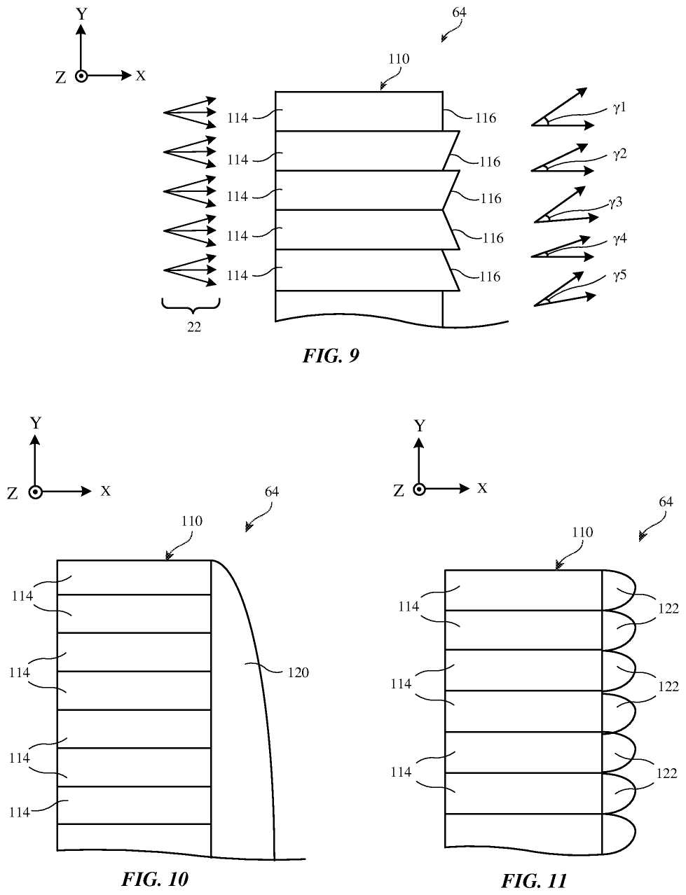

If desired, a single lens may be provided over array 110 to help direct light 22 to lens 34. For example, as shown in FIG. 10, a lens such as lens 120 may be provided over the output faces of array 110. Lens 120 may help to direct light 22 to lens 34 (FIG. 4). In another suitable arrangement, microlenses may be provided over the output face of each optical core 114. For example, as shown in FIG. 11, microlenses such as microlenses 122 may be provided over the output faces of each core 114. Microlenses 122 may have a relative position and/or shape that is selected to help tune the range of angles γ of the light 22 emitted by the underlying core 114. The relative position and/or shape of microlenses 122 may be independently varied across array 110 if desired. Any desired combination of the arrangements of FIGS. 8-11 may be used.

In accordance with an embodiment, a display system is provided that includes an emissive display panel configured to emit image light, a waveguide, an input coupling prism mounted to the waveguide, the input coupling prism is configured couple the image light into the waveguide, an output coupler on the waveguide and configured to couple the image light out of the waveguide and towards an eye box, a lens configured to direct the image light towards the input coupling prism, and optical components optically coupled between the emissive display panel and the lens, the optical components are configured to provide the image light with a field angle dependent pupil size upon coupling of the image light into the waveguide by the input coupling prism.

In accordance with another embodiment, the display panel includes first and second pixels that emit the image light, the optical components are configured to provide the image light emitted by the first pixel to the lens within a first range of angles, and the optical components are configured to provide the image light emitted by the second pixel to the lens within a second range of angles that is different from the first range of angles.

In accordance with another embodiment, the optical components include an aperture array.

In accordance with another embodiment, the aperture array includes a first aperture overlapping the first pixel and a second aperture overlapping the second pixel, the first aperture transmits the image light within the first range of angles, and the second aperture transmits the image light within the second range of angles.

In accordance with another embodiment, the aperture array includes a light stop between the first and second apertures.

In accordance with another embodiment, the optical components include a microlens array.

In accordance with another embodiment, the microlens array includes a first microlens overlapping the first pixel and a second microlens overlapping the second pixel, the first microlens provides the image light to the lens within the first range of angles, and the second microlens transmits the image light to the lens within the second range of angles.

In accordance with another embodiment, the first microlens has a first optical axis oriented in a first direction and the second microlens has a second optical axis oriented in a second direction that is different from the first direction.

In accordance with another embodiment, the optical components include an array of tapered optical tunnels.

In accordance with another embodiment, the array of tapered optical tunnels includes a first tapered optical tunnel overlapping the first pixel and a second tapered optical tunnel overlapping the second pixel, the first tapered optical tunnel provides the image light to the lens within the first range of angles, and the second tapered optical tunnel provides the image light to the lens within the second range of angles.

In accordance with another embodiment, the first tapered optical tunnel has a first input face and a first output face, the first output face is larger than the first input face, the second tapered optical tunnel has a second input face and a second output face, and the second output face is larger than the second input face.

In accordance with another embodiment, the first input face has a first area and the second input face has a second area that is different from the first area.

In accordance with another embodiment, the optical components include an optical fiber array.

In accordance with another embodiment, the optical fiber array includes a first optical fiber core overlapping the first pixel and a second optical fiber core overlapping the second pixel, the first optical fiber core provides the image light to the lens within the first range of angles, and the second optical fiber core provides the image light to the lens within the second range of angles.

In accordance with another embodiment, the first optical fiber core has a first index of refraction and the second optical fiber core has a second index of refraction that is different from the first index of refraction.

In accordance with another embodiment, the first optical fiber core has a first output facet oriented at a first angle and the second optical fiber core has a second output facet oriented at a second angle that is different from the first angle.

In accordance with another embodiment, the display system includes an additional lens that is mounted to and that overlaps the optical fiber array.

In accordance with another embodiment, the display system includes a first microlens overlapping an output face of the first optical fiber core and a second microlens overlapping an output face of the second optical fiber core.

In accordance with an embodiment, a display system is provided that includes an emissive display panel having an array of pixels configured to emit image light, a waveguide having an input coupler configured to couple the image light into the waveguide and having a holographic output coupler configured to direct the image light towards an eye box, a collimating lens configured to direct the image light towards the input coupler, and an array of apertures in a layer of opaque material, each aperture in the array of apertures overlaps a respective pixel in the array of pixels, the array of apertures includes apertures having different sizes, and the apertures having different sizes are configured to transmit the image light emitted by the array of pixels to the collimating lens within different respective angular ranges.

In accordance with an embodiment, a display system is provided that includes an emissive display panel having an array of pixels configured to emit image light, a waveguide having an input coupler configured to couple the image light into the waveguide and having a holographic output coupler configured to direct the image light towards an eye box, a collimating lens configured to direct the image light towards the input coupler, and an array of microlenses, each microlens in the array of microlenses overlaps a respective pixel in the array of pixels, the array of microlenses includes microlenses having different orientations, and the microlenses having different orientations are configured to provide the image light emitted by the array of pixels to the collimating lens within different respective angular ranges.

The foregoing is merely illustrative and various modifications can be made to the described embodiments. The foregoing embodiments may be implemented individually or in any combination.

What is claimed is:

1. A display system comprising:
an emissive display panel configured to emit image light;
a waveguide;
an input coupling prism mounted to the waveguide, wherein the input coupling prism is configured couple the image light into the waveguide;
an output coupler on the waveguide and configured to couple the image light out of the waveguide;
a lens configured to direct the image light towards the input coupling prism; and
optical components optically coupled between the emissive display panel and the lens, wherein the optical components are configured to provide the image light with a field angle dependent pupil size upon coupling of the image light into the waveguide by the input coupling prism.

2. The display system defined in claim 1, wherein the display panel comprises first and second pixels that emit the image light, wherein the optical components are configured to provide the image light emitted by the first pixel to the lens within a first range of angles, and wherein the optical components are configured to provide the image light emitted by the second pixel to the lens within a second range of angles that is different from the first range of angles.

3. The display system defined in claim 2, wherein the optical components comprise an aperture array.

4. The display system defined in claim 3, wherein the aperture array comprises a first aperture overlapping the first pixel and a second aperture overlapping the second pixel, wherein the first aperture transmits the image light within the first range of angles, and wherein the second aperture transmits the image light within the second range of angles.

5. The display system defined in claim 4, wherein the aperture array comprises a light stop between the first and second apertures.

6. The display system defined in claim 2, wherein the optical components comprise a microlens array.

7. The display system defined in claim 6, wherein the microlens array comprises a first microlens overlapping the first pixel and a second microlens overlapping the second pixel, wherein the first microlens provides the image light to the lens within the first range of angles, and wherein the second microlens transmits the image light to the lens within the second range of angles.

8. The display system defined in claim 7, wherein the first microlens has a first optical axis oriented in a first direction and the second microlens has a second optical axis oriented in a second direction that is different from the first direction.

9. The display system defined in claim 2, wherein the optical components comprise an array of tapered optical tunnels.

10. The display system defined in claim 9, wherein the array of tapered optical tunnels comprises a first tapered optical tunnel overlapping the first pixel and a second tapered optical tunnel overlapping the second pixel, wherein the first tapered optical tunnel provides the image light to the lens within the first range of angles, and wherein the second tapered optical tunnel provides the image light to the lens within the second range of angles.

11. The display system defined in claim 10, wherein the first tapered optical tunnel has a first input face and a first output face, wherein the first output face is larger than the first input face, wherein the second tapered optical tunnel has a second input face and a second output face, and wherein the second output face is larger than the second input face.

12. The display system defined in claim 11, wherein the first input face has a first area and the second input face has a second area that is different from the first area.

13. The display system defined in claim 2, wherein the optical components comprise an optical fiber array.

14. The display system defined in claim 13, wherein the optical fiber array comprises a first optical fiber core overlapping the first pixel and a second optical fiber core overlapping the second pixel, wherein the first optical fiber core provides the image light to the lens within the first range of angles, and wherein the second optical fiber core provides the image light to the lens within the second range of angles.

15. The display system defined in claim 14, wherein the first optical fiber core has a first index of refraction and wherein the second optical fiber core has a second index of refraction that is different from the first index of refraction.

16. The display system defined in claim 14, wherein the first optical fiber core has a first output facet oriented at a first angle and wherein the second optical fiber core has a second output facet oriented at a second angle that is different from the first angle.

17. The display system defined in claim 14, further comprising an additional lens that is mounted to and that overlaps the optical fiber array.

18. The display system defined in claim 14, further comprising a first microlens overlapping an output face of the first optical fiber core and a second microlens overlapping an output face of the second optical fiber core.

19. A display system comprising:
an emissive display panel having an array of pixels configured to emit image light;
a waveguide having an input coupler configured to couple the image light into the waveguide and having a holographic output coupler configured to couple the image light out of the waveguide;
a collimating lens configured to direct the image light towards the input coupler; and
an array of apertures in a layer of opaque material, wherein each aperture in the array of apertures overlaps a respective pixel in the array of pixels, wherein the array of apertures comprises apertures having different sizes, and wherein the apertures having different sizes are configured to transmit the image light emitted by the array of pixels to the collimating lens within different respective angular ranges.

20. A display system comprising:
an emissive display panel having an array of pixels configured to emit image light;
a waveguide having an input coupler configured to couple the image light into the waveguide and having a holographic output coupler configured to the image light out of the waveguide;
a collimating lens configured to direct the image light towards the input coupler; and
an array of microlenses, wherein each microlens in the array of microlenses overlaps a respective pixel in the array of pixels, wherein the array of microlenses comprises microlenses having different orientations, and wherein the microlenses having different orientations are configured to provide the image light emitted by the array of pixels to the collimating lens within different respective angular ranges.
